(19) United States
(12) Patent Application Publication
(10) Pub. No.: US 2012/0081677 A1
(43) Pub. Date: Apr. 5, 2012

(54) PROJECTION DISPLAY APPARATUS

(75) Inventors: Yuki Tanohata, Nishinomiya City (JP); Makoto Maeda, Nara- City (JP); Nobuyuki Kondo, Moriguchi City (JP); Shinya Matsumoto, Uji-City (JP)

(73) Assignee: SANYO ELECTRIC CO., LTD., Osaka (JP)

(21) Appl. No.: 13/250,476

(22) Filed: Sep. 30, 2011

(30) Foreign Application Priority Data
Sep. 30, 2010 (JP) 2010-222391

(51) Int. Cl. G03B 21/16; G03B 21/20

(52) U.S. Cl. 353/57; 353/119

(57) ABSTRACT

A projection display apparatus includes a housing member containing a light source, an imager that modulates light emitted from the light source, and a projection unit that projects the light emitted from the imager on a projection surface. The projection display apparatus includes: a movement mechanism that moves an optical unit configured by the light source, the imager, and the projection unit, in a direction perpendicular to the projection surface while maintaining a positional relationship among the light source, the imager, and the projection unit.

### CROSS REFERENCE TO RELATED APPLICATIONS

This application is based upon and claims the benefit of priority from prior Japanese Patent Application No. 2010-222391, filed on Sep. 30, 2010, the entire contents of which are incorporated herein by reference.

### BACKGROUND OF THE INVENTION

1. Field of the Invention

The present invention relates to a projection display apparatus including a housing member containing a light source, an imager that modulates light emitted from the light source, and a projection unit that projects the light emitted from the imager on a projection surface.

2. Description of the Related Art

Conventionally, there is known a projection display apparatus including a housing member containing a light source, an imager that modulate light emitted from the light source, and a projection unit that project the light emitted from the imager on a projection surface.

Generally, there is known a projection display apparatus having a mechanism that a housing member is tilted obliquely upward in order to project light on a projection surface arranged at a high level (for example, JP-A-2006-227050).

In recent years, there is proposed a projection display apparatus that projects light on a projection surface arranged on a desk or the like. Such a projection display apparatus requires a mechanism that a housing member is moved in a direction perpendicular to the projection surface in order to enlarge an image projected on the projection surface.

### SUMMARY OF THE INVENTION

A projection display apparatus according to a first feature includes a housing member (housing member 200) containing a light source (light source 10), an imager (DMD 70) that modulates light emitted from the light source, and a projection unit (projection unit 110) that projects the light emitted from the imager on a projection surface. The projection display apparatus includes: a movement mechanism that moves an optical unit configured by the light source, the imager, and the projection unit, in a direction perpendicular to the projection surface while maintaining a positional relationship among the light source, the imager, and the projection unit.

In the first feature, the housing member is configured by a first housing member (such as first housing member 410) and a second housing member (such as second housing member 420). The first housing member contains the optical unit. The second housing member is a pair of leg units (such as second housing member 420A and second housing member 420B) arranged in an angle-adjustable manner with respect to a pair of mutually-parallel side plates out of side plates of the first housing member, with a center set to an axis parallel to the projection surface. The pair of leg units is moved in conjunction with each other.

In the first feature, the housing member is configured by a first housing member (such as first housing member 710) and a second housing member (such as second housing member 720). The first housing member contains the optical unit. The second housing member has a hollow shape containing the first housing member and functions as the moving mechanism.

In the first feature, the second housing member includes a power supply unit (battery 140) that supplies the projection display apparatus with power.

In the first feature, the housing member is configured by a first housing member (such as first housing member 610) and a second housing member (such as second housing member 620). The first housing member contains the optical unit. The second housing member is a plate-shaped member provided to a first side plate in a pivotally movable manner, while a lower side of the first side plate is set to a pivotal movement axis, and the first side plate is one of side plates of the first housing member. The plate-shaped member has three scores (a score 621 to a score 623) parallel to the lower side of the first side plate, and is partitioned into four parts with the three scores in a longitudinal direction of the plate-shaped member. The four parts include a first leg unit (a first leg unit 624), a connection unit (a connection unit 625), a second leg unit (a second leg unit 626), and a third leg unit (a third leg unit 627) in order of distance from the lower side of the first side plate. The first leg unit, the second leg unit, and the third leg unit are equal in length in a longitudinal direction of the plate-shaped member. The connection unit coordinates angles of the first leg unit and the second leg unit.

In the first feature, the projection display apparatus includes a cooling member that cools down the optical unit. The volume of an airflow passage with respect to the cooling member is changed by moving the optical unit in a direction perpendicular to the projection surface.

A projection display apparatus according to a first feature includes a housing member containing a light source, an imager that modulates light emitted from the light source, and a projection unit that projects the light emitted from the imager on a projection surface. The projection display apparatus includes: a cooling member that cools down an optical unit configured by the light source, the imager, and the projection unit. The housing member is configured by a first housing member and a second housing member. A volume of an airflow passage with respect to the cooling member is changed by changing a positional relationship between the first housing member and the second housing member.

### BRIEF DESCRIPTION OF THE DRAWINGS

FIG. 1 is a diagram illustrating a projection display apparatus according to a first embodiment.

FIG. 2 is a diagram illustrating the projection display apparatus according to the first embodiment.

FIG. 3 is a diagram illustrating the projection display apparatus according to the first embodiment.

FIG. 4 is a diagram for explaining a movement mechanism according to the first embodiment.

FIG. 5 is a diagram for explaining the movement mechanism according to the first embodiment.

FIG. 6 is a diagram for explaining the movement mechanism according to the first embodiment.

FIG. 7 is a diagram for explaining the movement mechanism according to the first embodiment.

FIG. 8 is a diagram for explaining a movement mechanism according to a first modification.

FIG. 9 is a diagram for explaining a movement mechanism according to a second modification.

FIG. 10 is a diagram for explaining the movement mechanism according to the second modification.

FIG. 11 is a diagram for explaining a movement mechanism according to a third modification.

FIG. 12 is a diagram for explaining the movement mechanism according to the third modification.

FIG. 13 is a diagram for explaining the movement mechanism according to the third modification.

FIG. 14 is a diagram for explaining the movement mechanism according to the third modification.

FIGS. 15(a) to 15(c) are diagrams for explaining a movement mechanism according to a fourth modification.

FIG. 16 is a diagram for explaining a movement mechanism according to a fifth modification.

FIG. 17 is a diagram for explaining the movement mechanism according to the fifth modification.

FIG. 18 is a diagram illustrating a heatsink 830 according to the fifth modification.

FIG. 19 is a diagram illustrating the heatsink 830 according to the fifth modification.

FIG. 20 is a diagram illustrating the heatsink 830 according to a sixth modification.

FIG. 21 is a diagram illustrating the heatsink 830 according to the sixth modification.

FIG. 22 is a diagram illustrating the heatsink 830 according to a seventh modification.

FIG. 23 is a diagram illustrating the heatsink 830 according to the seventh modification.

FIG. 24 is a diagram illustrating the heatsink 830 according to the seventh modification.

FIG. 25 is a diagram illustrating the heatsink 830 according to the seventh modification.

FIG. 26 is a diagram illustrating the heatsink 830 according to the seventh modification.

FIG. 27 is a diagram illustrating the heatsink 830 according to the seventh modification.

FIG. 28 is a diagram illustrating a projection display apparatus 100 according to an eighth modification.

FIG. 29 is a diagram illustrating the projection display apparatus 100 according to the eighth modification.

### DETAILED DESCRIPTION OF THE EMBODIMENTS

Hereinafter, a projection display apparatus according to the present invention is explained with reference to drawings. In the following drawings, same or similar parts are denoted with same or similar reference numerals.

However, it should be noted that the drawings are merely exemplary and ratios of each dimension differ from the actual ones. Therefore, the specific dimensions, etc., should be determined in consideration of the following explanations. Moreover, it is needless to say that relations and ratios among the respective dimensions differ among the diagrams.

### Overview of Embodiments

A projection display apparatus according to an embodiment includes a housing member containing a light source, an imager that modulates light emitted from the light source, and a projection unit that projects the light emitted from the imager, on a projection surface. The projection display apparatus includes a movement mechanism that an optical unit configured by the light source, the imager, and the projection unit is moved in a direction perpendicular to the projection surface while a positional relationship among the light source, the imager, and the projection unit is maintained.

According to the characteristics described above, the movement mechanism allows the optical unit to move in a direction perpendicular to the projection surface. Therefore, an image projected on the projection surface can be easily enlarged. Furthermore, a positional relationship among the light source, the imager, and the projection unit can be maintained at the time of moving the optical unit in a direction perpendicular to the projection surface. Accordingly, it is unnecessary, for example, to modulate a path length of light emitted from the light source.

### First Embodiment

### (General Configuration of Projection Display Apparatus)

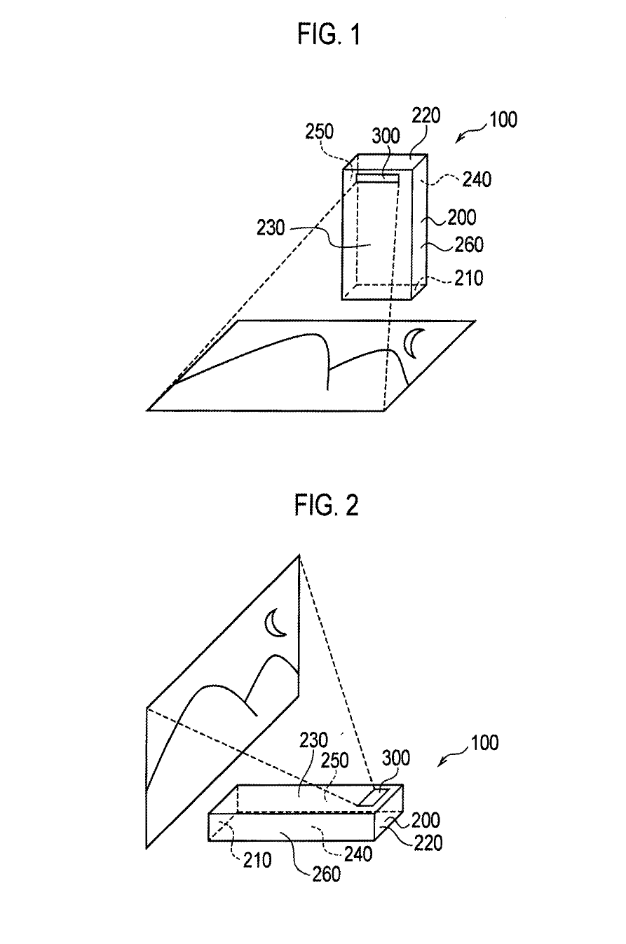

Hereinafter, a general configuration of a projection display apparatus according to a first embodiment is explained with reference to drawings. FIG. 1 is a diagram illustrating a projection display apparatus 100 (floor surface projection) according to the first embodiment. FIG. 2 is a diagram illustrating the projection display apparatus 100 (wall surface projection) according to the first embodiment.

As illustrated in FIGS. 1 and 2, the projection display apparatus 100 includes a housing member 200 and projects an image on a projection surface (not illustrated). The housing member 200 is provided with a transmission region 300 transmits light emitted from a projection unit 110 described later.

Herein, the projection surface may be arranged on a horizontal surface such as a floor surface or a top of a desk, as illustrated in FIG. 1, or may be arranged on a vertical surface such as a wall surface (for example, a screen), as illustrated in FIG. 2. That is, the projection display apparatus 100 may be disposed so as to project image light on a horizontal surface such as a floor surface or a top of a desk or may be disposed so as to project image light on a vertical surface such as a wall surface.

In a case illustrated in FIG. 1, the housing member 200 has a substantially rectangular parallelepiped shape. The housing member 200 includes a bottom plate 210, a top plate 220, a first side plate 230, a second side plate 240, a third side plate 250, and a fourth side plate 260.

The bottom plate 210 is faced toward a mounting surface of the housing member 200. The top plate 220 is arranged on the side opposite to the bottom plate 210. The first side plate 230 includes the transmission region 300. The second side plate 240 is arranged on the side opposite to the first side plate 230. The third side plate 250 and the fourth side plate 260 are the other side plates.

It is noted that the projection display apparatus 100 is about the same size as a plastic bottle having a volume of 200 ml to 2 l. For example, the projection display apparatus 100 has a volume of about 900 ml and a weight of about 800 g. An image displayed by the projection display apparatus is about 20 inches in size, for example. Furthermore, it should be noted that a distance between the projection display apparatus and the projection surface is extremely short.

### (Optical Configuration of Projection Display Apparatus)

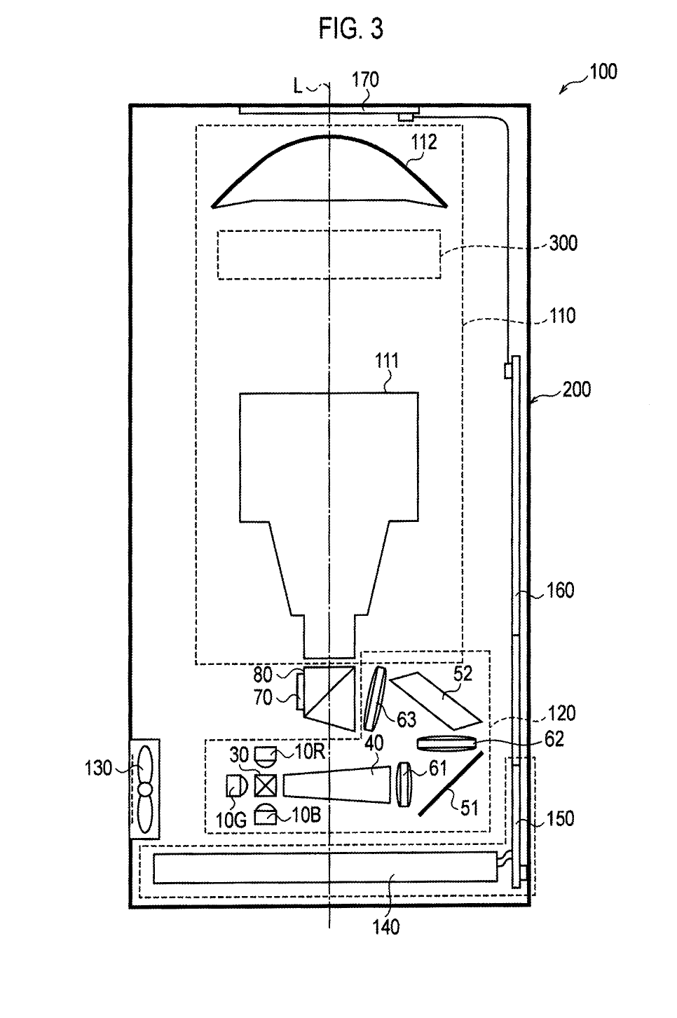

Hereinafter, an optical configuration of the projection display apparatus according to the first embodiment is explained with reference to drawings. FIG. 3 is a diagram mainly illustrating the optical configuration of the projection display apparatus 100 according to the first embodiment.

As illustrated in FIG. 3, the projection display apparatus 100 includes the projection unit 110, an illumination unit 120, a cooling fan 130, a battery 140, a power board 150, a main control board 160, and an operation board 170. Furthermore, the projection display apparatus 100 includes a DMD 70 and a reflection prism 80.

The projection unit 110 projects color component light (image light) emitted from the DMD 70, on the projection surface. Specifically, the projection unit 110 includes a projection lens group 111 and a reflection mirror 112.

The projection lens group 111 emits color component light (image light) emitted from the DMD 70, to the reflection mirror 112 side. The projection lens group 111 includes lenses such as a lens in a substantially circular shape with a center set to an optical axis L of the projection unit 110 and a lens in a shape (such as a semicircular shape corresponding to a lower half) configured by part of the substantially circular shape with the center set to the optical axis L of the projection unit 110.

It is noted that, as a lens included in the projection lens group 111 is positioned closer to the reflection mirror 112, its diameter becomes larger.

The reflection mirror 112 reflects color component light (image light) emitted from the projection lens group 111. The reflection mirror 112 focuses image light and then widens an angle thereof. Examples of the reflection mirror 112 include an aspheric surface mirror having a concave surface on a side of the projection lens group 111. Herein, the reflection mirror 112 has a shape (such as semicircular shape corresponding to a lower half) configured by part of the substantially circular shape with the center set to the optical axis L of the projection unit 110.

The transmission region 300 arranged in the housing member 200 transmits the image light focused by the reflection mirror 112. It is preferable that the transmission region 300 arranged in the housing member 200 is arranged in vicinity to a position in which the image light is focused by the reflection mirror 112.

The illumination unit 120 includes a light source 10, a dichroic prism 30, a rod integrator 40, a mirror 51, a mirror 52, a lens 61, and a lens 62, and a lens 63.

The light source 10 emits color component light beams of a plurality of colors, individually. Furthermore, the light source 10 may be arranged together with a heatsink which radiates heat generated in the light source 10. It is noted that the light source 10 is configured by a light source 10R, a light source 10G, and a light source B, for example.

The light source 10R is a light source emitting red component light R, such as a red LED (Light Emitting Diode) or a red LD (Laser Diode). The light source 10R may be arranged together with a heatsink made of a member with excellent thermal radiation performance, such as metal.

The light source 10G is a light source emitting green component light G, such as a green LED or a green LD. The light source 10G may be arranged together with a heatsink made of a member with excellent thermal radiation performance, such as metal.

The light source 10B is a light source emitting blue component light B, such as a blue LED or a blue LD. The light source 10R may be arranged together with a heatsink made of a member with excellent thermal radiation performance, such as metal.

The dichroic prism 30 combines red component light R emitted from the light source 10R, green component light G emitted from the light source 10G, and blue component light B emitted from the light source 10B.

The rod integrator 40 includes a light incidence surface, a light emission surface, and light reflecting side surface arranged from the periphery of the light incidence surface to the periphery of the light emission surface. The rod integrator 40 equalizes color component light emitted from the dichroic prism 30. Specifically, the rod integrator 40 equalizes color component light by reflecting the color component light on the light reflecting side surface. The rod integrator 40 may be a solid rod made of glass or may be a hollow rod with an inner surface configured by a mirror surface.

For example, the rod integrator 40 in the first embodiment has a tapered shape that a cross-section surface perpendicular to a light-traveling direction becomes larger toward the traveling direction of light emitted from the light source 10. However, the embodiment is not limited thereto. The rod integrator 40 may have an inverse tapered shape that a cross-section surface perpendicular to a light-traveling direction becomes smaller toward the traveling direction of light emitted from the light source 10.

Each of the mirror 51 and the mirror 52 is a reflection mirror that bends a light path in order to guide to the DMD 70, light emitted from the rod integrator 40.

Each of the lens 61, the lens 62, and the lens 63 is a relay lens that substantially forms an image with color component light on the DMD70 while restraining expansion of the color component light emitted from the light source 10.

The cooling fan 130 is communicated with an exterior of the housing member 200 so as to radiate heat inside the housing member 200. Alternatively, the cooling fan 130 may feed air outside the housing member 200 in the housing member 200. For example, the cooling fan 130 is arranged in vicinity to the light source 10 so as to have a configuration to cool down the light source 10.

The battery 140 stores power to be supplied to the projection display apparatus 100.

The power board 150 is connected to the battery 140 and includes a power converter circuit that converts AC power into DC power.

The main control board 160 includes a main control circuit that controls operation of the projection display apparatus 100.

The operation board 170 is connected to an operation unit (such as a button) arranged in the projection display apparatus 100 and transmits to the main control board 160 (main control circuit) an operation signal input from the operation unit.

The DMD 70 is configured by a plurality of micro-mirrors, and these plurality of micro-mirrors are movable. Basically, each of the micro-mirrors corresponds to one pixel. The DMD 70 changes an angle of each micro-mirror so as to switch whether or not to reflect color component light so that the color component light is guided as effective light to the projection unit 110 side.

The reflection prism 80 transmits to the DMD 70 side, light emitted from the illumination unit 120. On the other hand, the reflection prism 80 reflects light emitted from the DMD 70, on the projection unit 110 side.

### (Configuration of Movement Mechanism)

Hereinafter, a configuration of the movement mechanism according to the first embodiment is explained with reference to drawings. The movement mechanism is a mechanism that an optical unit configured by the light source 10, the DMD 70, and the projection unit 110 is moved in a direction perpendicular to the projection surface. The optical unit may include a mechanism included in the illumination unit 120, other than the mechanism described above.

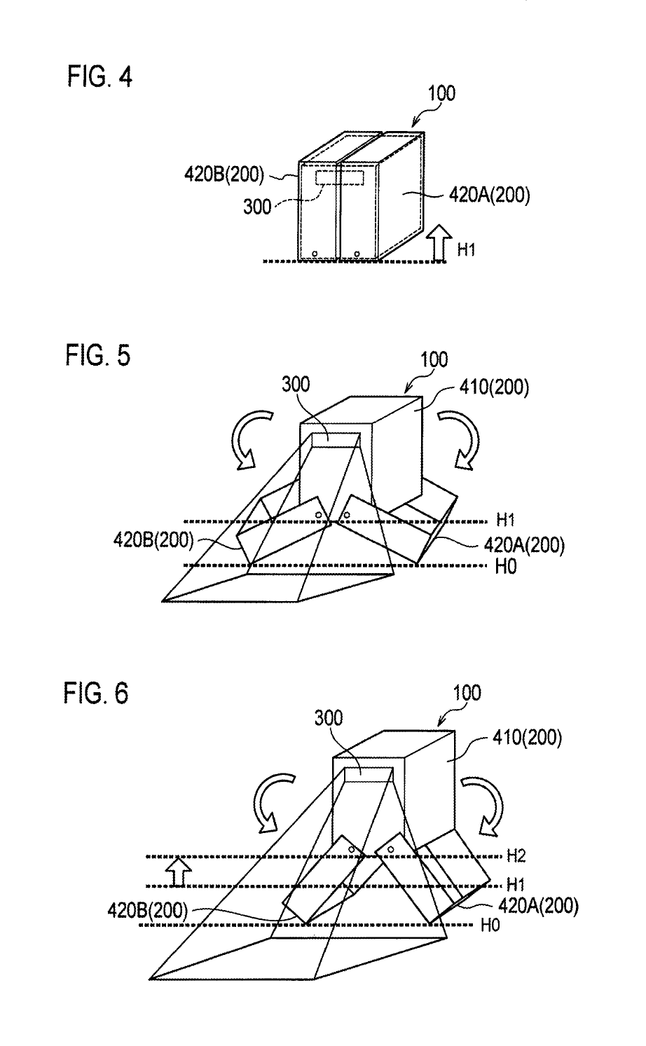

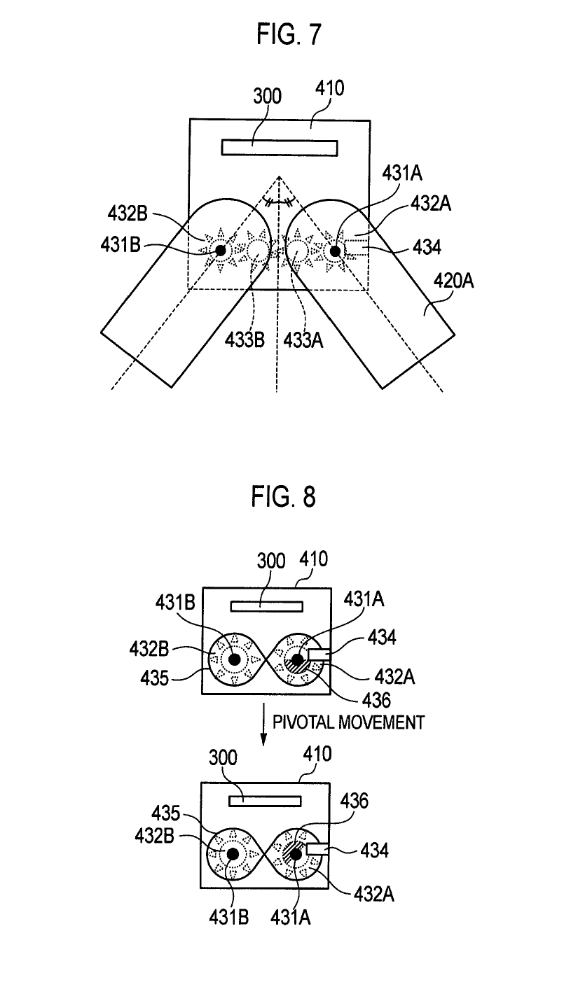

FIGS. 4 to 6 are diagrams for explaining the movement mechanism according to the first embodiment. As illustrated in FIGS. 4 to 6, the housing member 200 includes a first housing member 410 and a second housing member 420.

The first housing member 410 is a housing member containing the optical unit configured by the light source 10, the DMD 70, and the projection unit 110.

The second housing member 420 is a cover that covers the first housing member 410. Specifically, the second housing member 420 is a pair of leg units (a second housing member 420A and a second housing member 420B) arranged in an angle-adjustable manner with respect to a pair of mutually-parallel side plates out of side plates of the first housing member 410, with the center set to the axis parallel to the projection surface.

Herein, as illustrated in FIGS. 5 and 6, a height of the optical unit contained in the first housing member 410 is changed in association with pivotal movement of the second housing member 420A and the second housing member 420B. In other words, the second housing member 420A and the second housing member 420B function as a movement mechanism.

For example, in a case of setting a height of the projection surface to HO as illustrated in FIG. 5, when the second housing member 420A and the second housing member 420B are pivotally moved, a height of the optical unit is increased by H1-H0. Furthermore, when the second housing member 420A and the second housing member 420B are pivotally moved further, as illustrated in FIG. 6, a height of the optical unit is increased by H2-H1.

Herein, it is preferable that the second housing member 420A and the second housing member 420B are pivotally moved in conjunction with each other. Specifically, the first housing member 410 includes a pivotal movement axis 431 (a pivotal movement axis 431A and a pivotal movement axis 431B), a cogwheel 432 (a cogwheel 432A and a cogwheel 432B), a cogwheel 433 (a cogwheel 433A and a cogwheel 433B), and a stopper 434. The pivotal movement axis 431A is a pivotal movement axis for the second housing member 420A while the pivotal movement axis 431B is a pivotal movement axis for the second housing member 420B.

The cogwheel 432A is pivotally moved with the pivotal movement axis 431A as the center while the cogwheel 432B is pivotally moved with the pivotal movement axis 431B as the center. It is noted that cogs arranged in the cogwheel 432A are arranged in part of the entire perimeter of the cogwheel 432A, and pivotal movement of the cogwheel 432A is regulated by the stopper 434 described later.

The cogwheel 433A is in engagement with the cogwheel 432A and the cogwheel 433B while the cogwheel 433B is in engagement with the cogwheel 432B and the cogwheel 433A.

The stopper 434 regulates pivotal movement of the cogwheel 432A. That is, the stopper 434 regulates movement of cogs arranged in part of the entire perimeter of the cogwheel 432A.

### (Operation and Effect)

In the first embodiment, the optical unit is moved in a direction perpendicular to the projection surface in association with pivotal movement of the second housing member 420A and the second housing member 420B. Therefore, an image projected on the projection surface can be easily enlarged. Furthermore, a positional relationship among the light source, the imager, and the projection unit can be maintained at the time of moving the optical unit in a direction perpendicular to the projection surface. It is therefore unnecessary, for example, to modulate a path length of light emitted from the light source.

In the first embodiment, the second housing member 420A and the second housing member 420B are pivotally moved in conjunction with each other. Therefore, a tilt of the optical unit contained in the first housing member 410 is restrained.

### [First Modification]

Hereinafter, a first modification of the first embodiment is explained. The explanation below is based on the differences with respect to the first embodiment.

In the first modification, as illustrated in FIG. 8, a chain 435 is arranged instead of the cogwheel 433A and the cogwheel 433B, in comparison with the first embodiment.

The chain 435 has an endless shape and is wound around the cogwheel 432A and the cogwheel 432B.

In the first modification, cogs are arranged in the entire perimeter of the cogwheel 432A while the cogwheel 432A includes a protrusion 436 protruded in an axial direction of the pivotal movement axis 431A. The stopper 434 regulates movement of the protrusion 436 arranged in the cogwheel 432A.

Furthermore, the stopper 434 may be configured so as to be removably inserted into an opening arranged in the first housing member 410. In such a case, instead of the protrusion 436 arranged in the cogwheel 432A, the stopper 434 has a shape so as to be engaged with the cogs of the cogwheel 432A. In this manner, a height of the optical unit can be adjusted with the stopper 434 being removed from the opening while movement of the cogwheel 432A is regulated to fix a height of the optical unit with the stopper 434 being inserted into the opening.

### [Second Modification]

Hereinafter, a second modification of the first embodiment is explained. The explanation below is based on the differences with respect to the first embodiment.

Specifically, the second housing member in the first embodiment is a cover that covers the first housing member 410. On the other hand, the second housing member in the second modification is a housing member containing the battery 140.

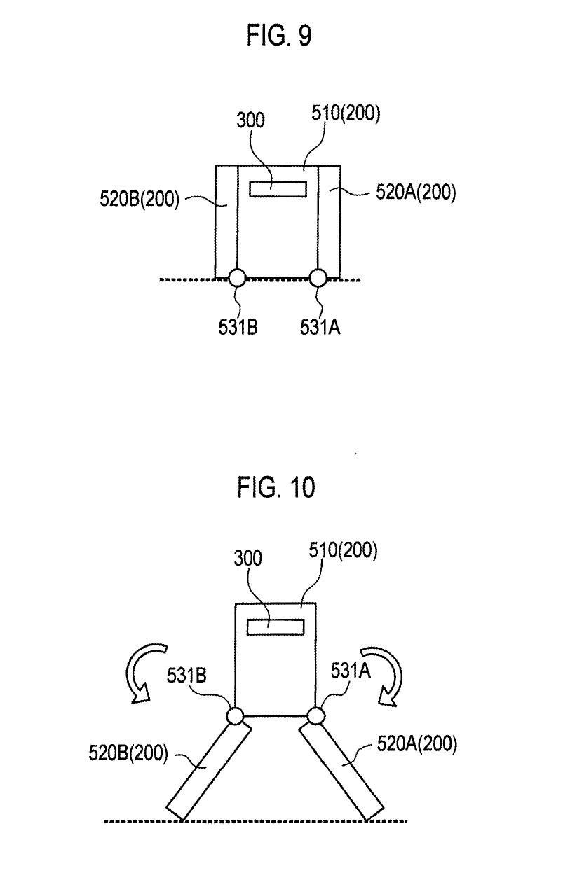

FIGS. 9 and 10 are diagrams for explaining a movement mechanism according to the first embodiment. As illustrated in FIGS. 9 and 10, the housing member 200 includes a first housing member 510 and a second housing member 520.

The first housing member 510 is a housing member containing the optical unit configured by the light source 10, the DMD 70, and the projection unit 110, likewise the first housing member 410.

The second housing member 520 is a housing member containing the battery 140. Specifically, the second housing member 520 is a pair of leg units (a second housing member 520A and a second housing member 520B) arranged in a pivotally movable manner to the pair of mutually-parallel side plates out of side plates of the first housing member 410, with the center set to the axis parallel to the projection surface.

The second housing member 520A is configured in a pivotally movable manner with a pivotal movement axis 531A as the center. It is noted that, since a method of pivotally moving the second housing member 520A is the same as that of the second housing member 420A, detailed description of the pivotally moving method is omitted.

The second housing member 520B is configured in a pivotally movable manner with the pivotal movement axis 531B as the center. It is noted that, since a method of pivotally moving the second housing member 520B is the same as that of the second housing member 420B, detailed description of the pivotally moving method is omitted.

Herein, a height of the optical unit contained in the first housing member 510 is changed in association with pivotal movement of the second housing member 520A and the second housing member 520B. In other words, the second housing member 520A and the second housing member 520B function as a movement mechanism.

It is noted that the second housing member 520A and the second housing member 520B are preferably moved pivotally in conjunction with each other, likewise the first embodiment.

In the second modification, the second housing member 520 contains the battery 140. However, the embodiment is not limited thereto. The second housing member 520 may contain an AC/DC converter unit.

### (Operation and Effect)

In the second modification, the second housing member 520 includes a power supply unit such as the battery 140. Therefore, since gravity of the second housing member 520 is high, stability of the projection display apparatus 100 can be maintained even in a case of changing a height of the optical unit contained in the first housing member 510.

### [Third Modification]

Hereinafter, a third modification of the first embodiment is explained. The explanation below is based on the differences with respect to the first embodiment.

Specifically, the second housing member in the first embodiment is the pair of leg units. On the other hand, in the third modification, the second housing is a plate-shaped member arranged in a pivotally movable manner to the first side plate, with the pivotal movement axis set to a lower side of a first side plate (for example, the first side plate 230 illustrated in FIG. 1) out of side plates of the first housing member.

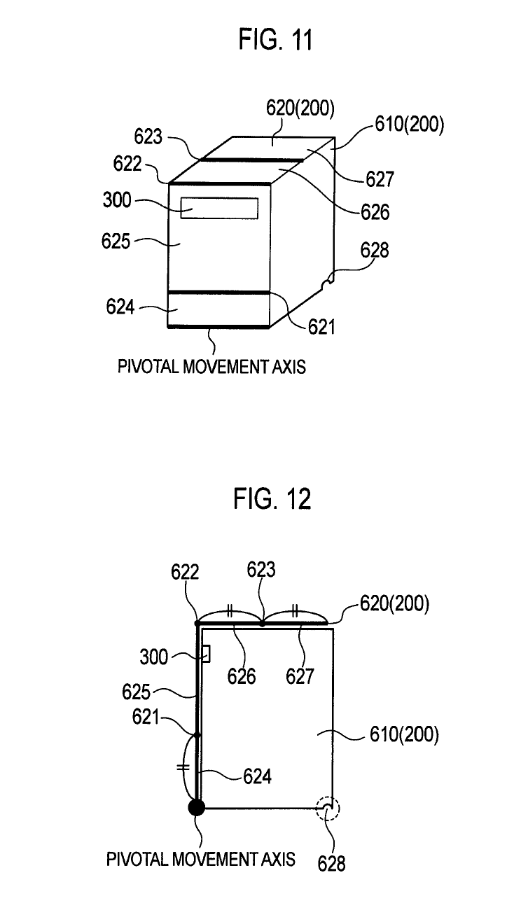

FIGS. 11 to 14 are diagrams for explaining a movement mechanism according to the third modification. As illustrated in FIGS. 11 to 14, the housing member 200 includes a first housing member 610 and a second housing member 620.

The first housing member 610 is a housing member containing the optical unit configured by the light source 10, the DMD 70, and the projection unit 110, likewise the first housing member 410.

The second housing member 620 is a plate-shaped member arranged in a pivotally movable manner to the first side plate (for example, the first side plate 230 illustrated in FIG. 1) with the pivotal movement axis set to the lower side of the first side plate out of the side plates of the first housing member.

Specifically, the second housing member 620 includes three scores (a score 621, a score 622, and a score 623). The second housing member 620 is partitioned into four parts with the three scores. The four parts include a first leg unit 624, a connection unit 625, a second leg unit 626, and a third leg unit 627 in order of distance from the lower side (pivotal movement axis) of the first side plate (for example, the first side plate 230 illustrated in FIG. 1). The second housing member 620 includes a fitting groove 628.

The score 621, the score 622, and the score 623 are approximately parallel to the lower side (pivotal movement axis) of the first side plate (for example, the first side plate 230 illustrated in FIG. 1).

The first leg unit 624, the second leg unit 626, and the third leg unit 627 are equal in length in a longitudinal direction of the second housing member 620 (plate-shaped member) as illustrated in FIG. 12. It is noted that the longitudinal direction of the second housing member 620 is a direction perpendicular to the scores or the pivotal movement axis.

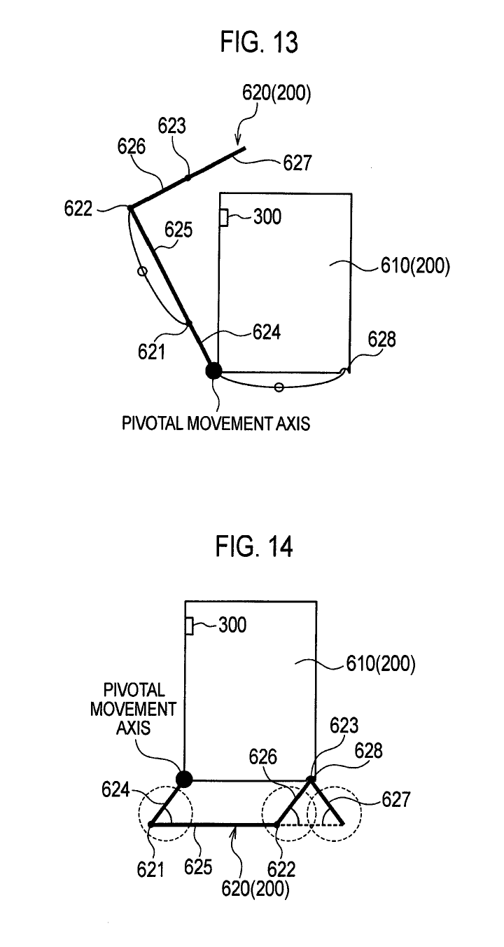

The connection unit 625 is equal in length to a bottom plate of the first housing member 610 in a longitudinal direction of the second housing member 620 (plate-shaped member), as illustrated in FIG. 13.

The fitting groove 628 is arranged in the bottom plate of the first housing member 610. The fitting groove 628 extends in a direction approximately parallel to the lower side (pivotal movement axis) of the first side plate (for example, the first side plate 230 illustrated in FIG. 1). The fitting groove 628 is a groove that receives the score 623, as illustrated in FIG. 14.

As illustrated in FIG. 14, the connection unit 625 coordinates angles of the first leg unit 624, the second leg unit 626, and the third leg unit 627. Change in the angles of the first leg unit 624, the second leg unit 626, and the third leg unit 627 results in change in height of the optical unit contained in the first housing member 610. In other words, the second housing member 620 functions as a movement mechanism.

### (Operation and Effect)

In the third modification, the second housing member 620 is configured by a plurality of foldable parts (the first leg unit 624, the connection unit 625, the second leg unit 626, and the third leg unit 627). The first leg unit 624, the second leg unit 626, and the third leg unit 627 are equal in length in a longitudinal direction of the second housing member 620 (plate-shaped member). Accordingly, the optical unit can be moved in a direction perpendicular to the projection surface by adjusting angles of the first leg unit 624, the second leg unit 626, and the third leg unit 627.

The first leg unit 624, the connection unit 625, the second leg unit 626, and the third leg unit 627 are arranged in order of distance from the pivotal movement axis. In this manner, the connection unit 625 can coordinate angles of the first leg unit 624, the second leg unit 626, and the third leg unit 627.

### [Fourth Modification]

Hereinafter, a fourth modification of the first embodiment is explained. The explanation below is based on the differences with respect to the first embodiment.

Specifically, in the first embodiment, the second housing member is the pair of leg units. On the other hand, the second housing member in the fourth modification has a hollow shape containing the first housing member.

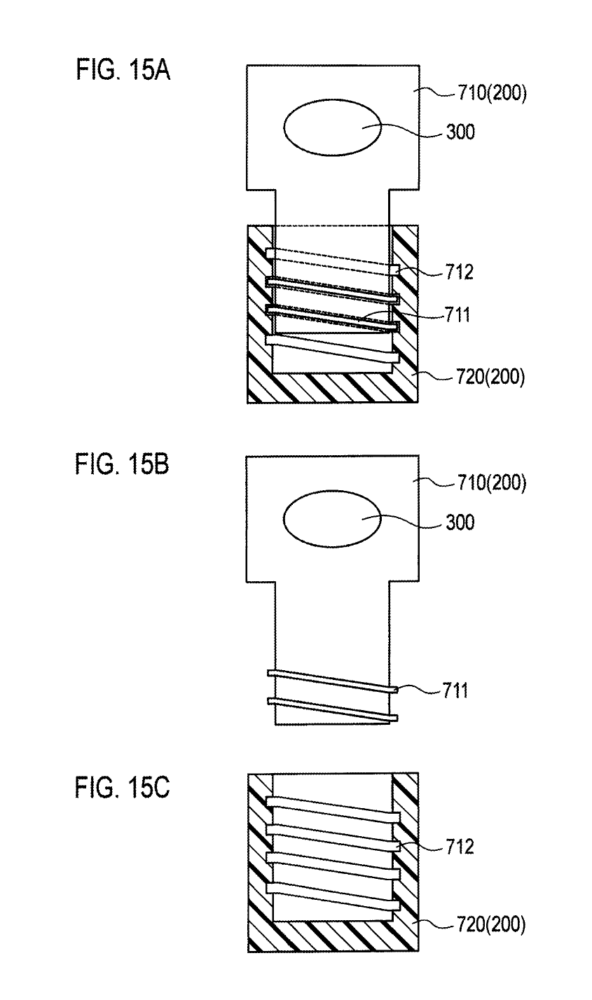

FIGS. 15(a) to 15(c) are diagrams for explaining a movement mechanism according to the fourth modification. Specifically, FIG. 15(a) is a diagram illustrating a first housing member 710 and a second housing member 720. FIG. 15(b) is a diagram illustrating the first housing member 710. FIG. 15(c) is a diagram illustrating the second housing member 720. Herein, it is noted that the second housing member 720 is illustrated with respect to a cross section in FIGS. 15(a) and 15(c). However, part of a groove 721 described later is illustrated for the purpose of clear explanation.

As shown in FIGS. 15(a) to 15(c), the housing member 200 includes the first housing member 710 and the second housing member 720.

The first housing member 710 is a housing member containing the optical unit configured by the light source 10, the DMD 70, and the projection unit 110, likewise the first housing member 410. A helical protrusion 711 is arranged in an outer wall of the first housing member 710. To be more specific, the protrusion 711 is preferably arranged on a lower side of the first housing member 710 so as to make the protrusion 711 invisible even in a case where the first housing member 710 is moved upward.

The second housing member 720 has a hollow shape containing the first housing member 710. The second housing member 720 contains the battery 140. The second housing member 720 includes the helical groove 721. The groove 721 arranged in the second housing member 720 fits with the protrusion 711 arranged in the first housing member 710.

Herein, a height of the optical unit contained in the first housing member 710 is changed by pivotally moving the first housing member 710 with the center set to the axis extending in a direction perpendicular to the projection surface. In other words, the second housing member 720 functions as a movement mechanism.

In the fourth modification, the second housing member 720 contains the battery 140. However, the embodiment is not limited thereto. The second housing member 720 may contain the AC/DC converter unit.

### (Operation and Effect)

In the fourth modification, the second housing member 720 has a hollow shape containing the first housing member 710 and includes a power supply unit such as the battery 140. Therefore, since gravity of the second housing member 720 is high, stability of the projection display apparatus 100 can be maintained even in a case of changing a height of the optical unit contained in the first housing member 710.

### [Fifth Modification]

Hereinafter, a fifth modification of the first embodiment is explained. The explanation below is based on the differences with respect to the first embodiment.

Specifically, explained in the fifth modification is a cooling member (such as a heatsink) cooling down a heat source such as the light source 10.

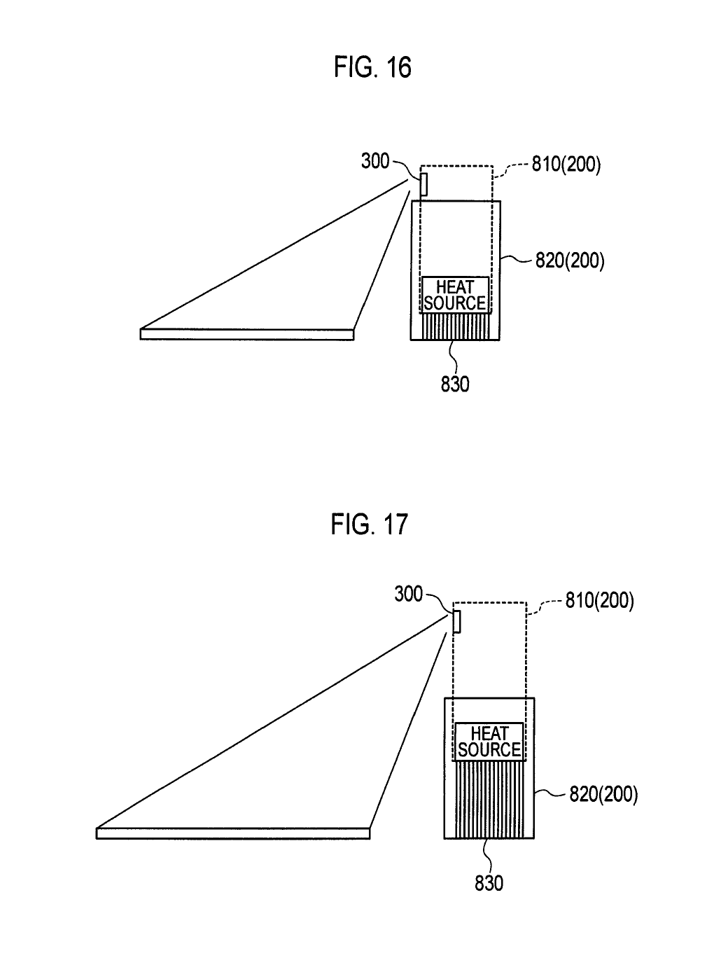

FIGS. 16 to 19 are diagrams for explaining the cooling member according to the fifth modification. In the fifth modification, a heatsink is cited as an example of the cooling member. As illustrated in FIGS. 16 and 17, the housing member 200 includes a first housing member 810 and a second housing member 820.

The first housing member 810 is a housing member containing the optical unit configured by the light source 10, the DMD 70, and the projection unit 110, likewise the first housing member 410.

The second housing member 820 is a housing member containing part of the cooling member (herein, a heatsink 830). It is noted that the second housing member 820 may contain the battery 140.

It is noted that the projection display apparatus 100 includes a movement mechanism that the optical unit contained in the first housing member 810 is moved in a direction perpendicular to the projection surface.

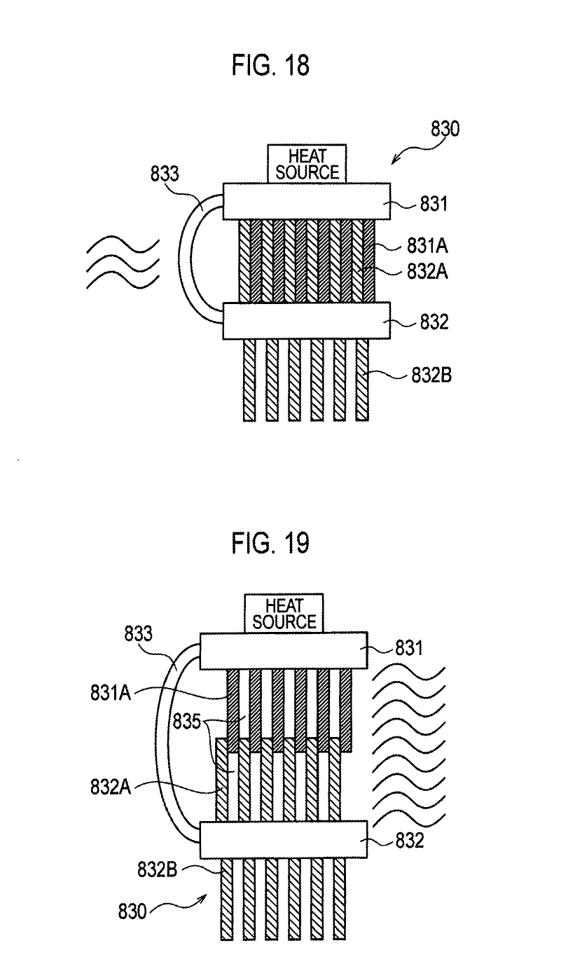

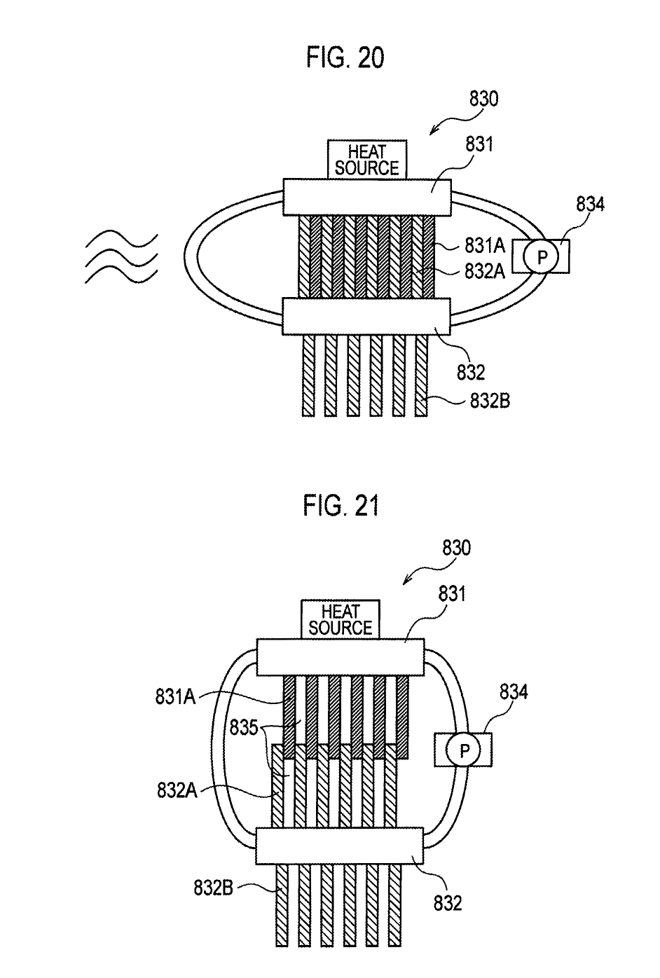

Herein, the heatsink 830 includes an upper-side heatsink 831, a lower-side heatsink 831, and a heat pipe 833, as illustrated in FIGS. 18 and 19.

The upper-side heatsink 831 has a comb-teeth shape including a plurality of fins (downward fins 831A) protruded downward. The lower-side heatsink 832 has a comb-teeth shape including a plurality of fins (upward fins 832A) protruded upward and a plurality of fins (downward fins 832B) protruded downward. The heat pipe 833 is made of a member having a high thermal conductivity, such as copper, and has a function of transferring heat of the upper-side heat sink 831 to the lower-side heat sink 832. Furthermore, the heat pipe 833 is made of a flexibly bendable member.

It is noted that the downward fins 831A of the upper-side heatsink 831 and the upward fins 832A of the lower-side heatsink 832 are arranged alternately. Furthermore, the downward fins 831A of the upper-side heatsink 831 are disposed so as to be in contact with the upward fins 832A of the lower-side heatsink 832.

Therefore, in a case where the optical unit contained in the first housing member 810 is positioned at a low level, as illustrated in FIG. 16, the downward fins 831A of the upper-side heatsink 831 and the upward fins 832A of the lower-side heatsink 832 overlap each other, as illustrated in FIG. 18. On the other hand, as illustrated in FIG. 17, in a case where the optical unit contained in the first housing member 810 is positioned at a high level, the downward fins 831A of the upper-side heatsink 831 and the upward fins 832A of the lower-side heatsink 832 are exposed each other, as illustrated in FIG. 19.

It is noted that the upper-side heatsink 831 is contained in the first housing member 810 while the lower-side heatsink 832 and the heat pipe 833 are contained in the second housing member 820.

As described above, the optical unit contained in the first housing member 810 is moved in a direction perpendicular to the projection surface so that a volume of an airflow passage 835 is change with respect to the heatsink 830.

It is noted that in the fifth modification, the downward fins 831A of the upper-side heatsink 831 are disposed so as to be in contact with the upward fins 832A of the lower-side heatsink 832, as illustrated in FIG. 18. However, the fifth modification is not limited thereto. Specifically, the airflow passage 835 may be formed between the downward fins 831A of the upper-side heatsink 831 and the upward fins 832A of the lower-side heatsink 832.

### (Operation and Effect)

In the fifth modification, a volume of the airflow passage 835 with respect to the heatsink 830 is changed by moving the optical unit contained in the fist housing member 810 in a direction perpendicular to the projection surface. In other words, in a case where the optical unit contained in the first housing member 810 is positioned at high level and increase in light quantity is required for the light emitted from the light source 10, a volume of the airflow passage 835 with respect to the heatsink 830 is increased. Therefore, the heat source such as the light source 10 can be cooled down effectively, and the quantity of light emitted from the light source 10 can be increased if necessary.

### [Sixth Modification]

Hereinafter, a sixth modification of the first embodiment is explained. The explanation below is based on the differences with respect to the fifth modification.

Specifically, as illustrated in FIGS. 20 and 21, a heatsink 830 in the sixth modification includes a liquid-cooling device 834 instead of the heat pipe 833.

The liquid-cooling device 834 has a function of transferring heat of the upper-side heatsink 831 to the lower-side heatsink 832. Specifically, the liquid-cooling device 834 includes a coolant passage and a pump, in which a coolant is circulated in the coolant passage by the pump.

### [Seventh Modification]

Hereinafter, a seventh modification of the first embodiment is explained. The explanation below is based on the differences with respect to the fifth modification.

The heatsink 830 in the fifth modification is configured by the upper-side heatsink 831 the lower-side heatsink 832 each having a comb-teeth shape. On the other hand, a heatsink 830 in the seventh modification has another configuration.

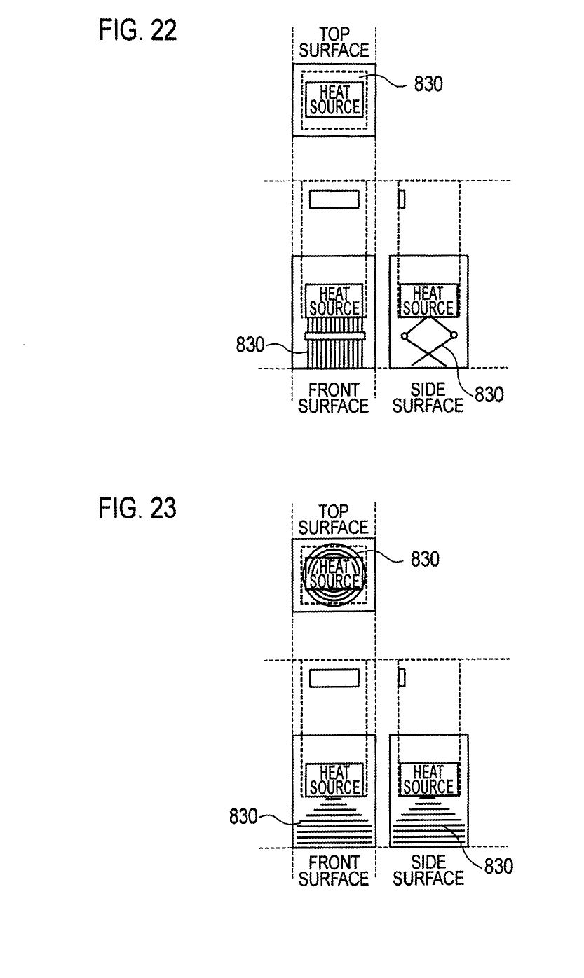

As illustrated in FIG. 22, for example, the heatsink 830 may have a configuration that a rod-shaped fin arranged in a lattice form is foldable on a joint part.

Alternatively, as illustrated in FIG. 23, the heatsink 830 may have a configuration that is wounded in a helical form.

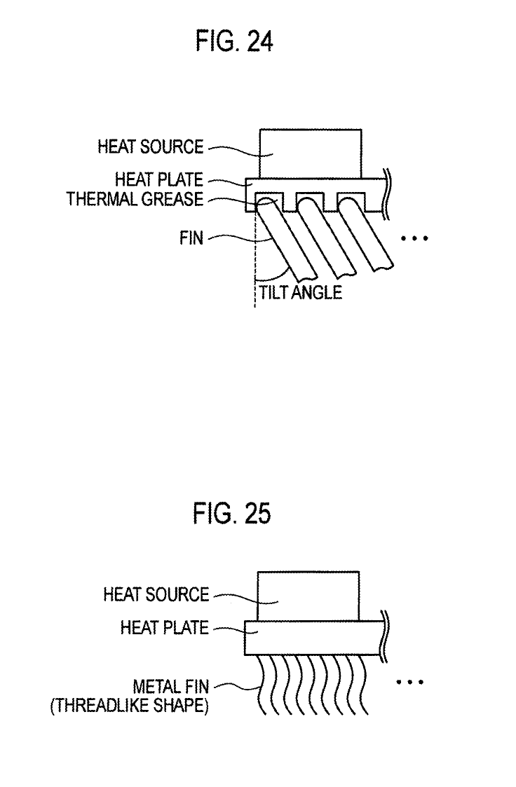

Alternatively, as illustrated in FIG. 24, the heatsink 830 may have a configuration that a fin is bonded to a heat plate using thermal grease. It is noted that the heatsink 830 is configured so that an angle of the fin is changeable.

Alternatively, as illustrated in FIG. 25, the heatsink 830 may have a configuration that a threadlike fin is arranged in a heat plate.

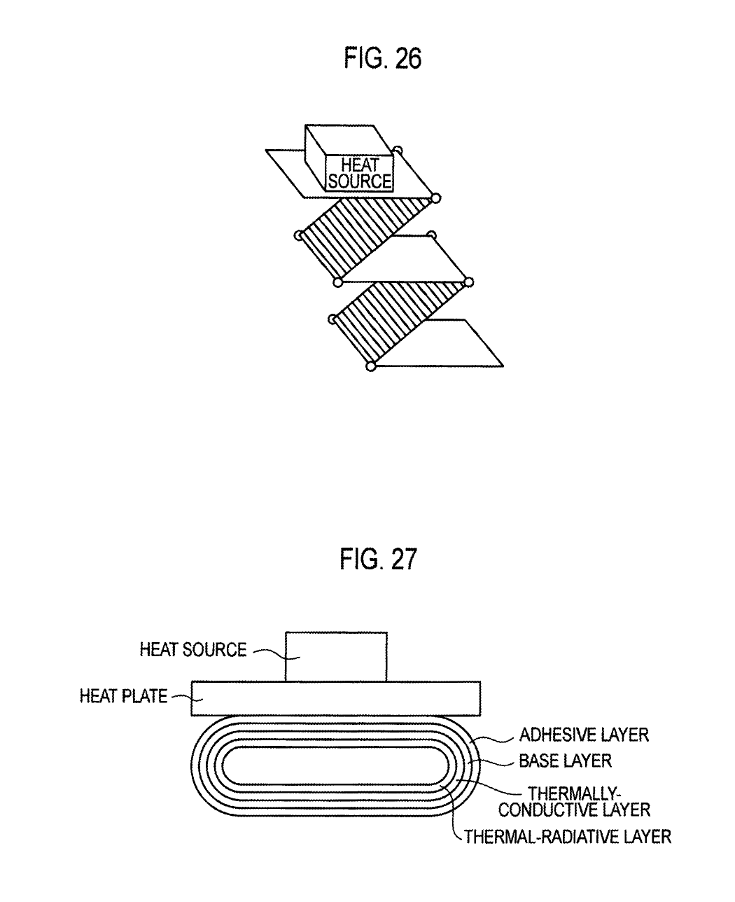

Alternatively, as illustrated in FIG. 26, the heatsink 830 may be configured by a sheet made of an elastic member. For example, the sheet includes an adhesive layer, a base layer such as polyimide, a thermally-conductive layer such as copper, and a thermal-radiative layer made of ceramic system coating. The sheet has a configuration in a cylindrical shape made up of laminated layers while having elasticity. It is noted that the thermal-radiative layer radiates heat by converting heat transferred through the thermally-conductive layer, into a far-infrared ray. Alternatively, as illustrated in FIG. 27, the heatsink 830 may have a configuration that a plate-shaped fin is foldable on a joint part.

### [Eighth Modification]

Hereinafter, an eighth modification of the first embodiment is explained. The explanation below is based on the differences with respect to the fifth modification.

Described as an example in the fifth modification is case where the heatsink 830 is arranged in the projection display apparatus 100 in portrait orientation (floor surface projection). On the other hand, the eighth modification describes an example case where a heatsink 830 is arranged in the projection display apparatus 100 in a landscape orientation (wall surface projection).

Specifically, the housing member 200 in the eighth modification includes the first housing member 810 and the second housing member 820, likewise the fifth modification. A volume of the airflow passage 835 with respect to the heatsink 830 is changed by changing a positional relationship between the first housing member 810 and the second housing member 820.

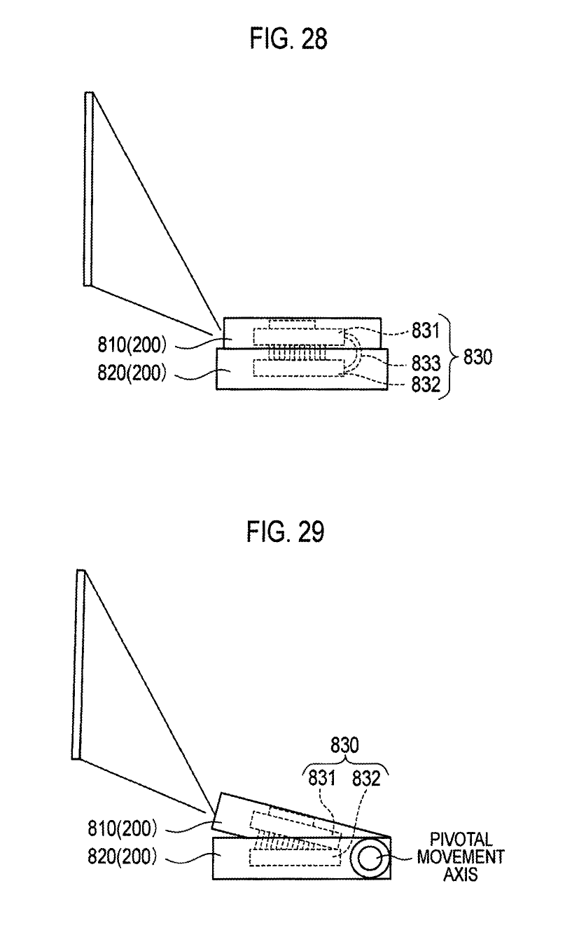

For example, as illustrated in FIG. 28, in a case where the first housing member 810 is moved in a direction perpendicular to the projection surface, the downward fins 831A of the upper-side heatsink 831 and the upward fins 832A of the lower-side heatsink 832 are exposed each other.

Alternatively, as illustrated in FIG. 29, in a case where the first housing member 810 is pivotally moved with the pivotal movement axis as the center, the downward fins 831A of the upper-side heatsink 831 and the upward fins 832A of the lower-side heatsink 832 are exposed each other.

### (Operation and Effect)

In the eighth modification, a volume of the airflow passage 835 with respect to the heatsink 830 is changed by changing a positional relationship between the first housing member 810 and the second housing member 820. Therefore, the heat source such as the light source 10 can be cooled down effectively, and the quantity of light emitted from the light source 10 can be increased if necessary.

### Other Embodiments

The present invention is explained through the above embodiment, but it must not be assumed that this invention is limited by the statements and drawings constituting a part of this disclosure. From this disclosure, various alternative embodiments, examples and operational technologies will become apparent to those skilled in the art.

The above embodiment merely described a DMD (Digital Micromirror Device) as an example of an imager. The imager may be a reflection liquid crystal panel or may be a transmissive liquid crystal panel. The above embodiment described an example case where the light source is an LED or LD. However, the light source may be an EL (Electro Luminescence).

Apart from the above embodiment, the projection display apparatus including the light source, the imager, and the projection unit may include a leg unit that is configured so as to be expandable and contractible in a direction perpendicular to the projection surface. In a case of arranging a plurality of expandable and contractible leg units, for example, it is preferable that the plurality of leg units are connected to expand and contract in conjunction with each other. Furthermore, such a leg unit may be configured so as to be detachable from the projection display apparatus.

1. A projection display apparatus including a housing member containing a light source, an imager that modulates light emitted from the light source, and a projection unit that projects the light emitted from the imager on a projection surface, the projection display apparatus comprising:
a movement mechanism that moves an optical unit configured by the light source, the imager, and the projection unit, in a direction perpendicular to the projection surface while maintaining a positional relationship among the light source, the imager, and the projection unit.

2. The projection display apparatus according to claim 1, wherein the housing member is configured by a first housing member and a second housing member,
the first housing member contains the optical unit,
the second housing member is a pair of leg units arranged in an angle-adjustable manner with respect to a pair of mutually-parallel side plates out of side plates of the first housing member, with a center set to an axis parallel to the projection surface, and
the pair of leg units are moved in conjunction with each other.

3. The projection display apparatus according to claim 1, wherein
the housing member is configured by a first housing member and a second housing member,
the first housing member contains the optical unit, and
the second housing member has a hollow shape containing the first housing member and functions as the moving mechanism.

4. The projection display apparatus according to claim 2, wherein
the second housing member includes a power supply unit that supplies the projection display apparatus with power.

5. The projection display apparatus according to claim 1, further comprising a cooling member that cools down the optical unit, wherein
a volume of an airflow passage with respect to the cooling member is changed by moving the optical unit in a direction perpendicular to the projection surface.

6. A projection display apparatus including a housing member containing a light source, an imager that modulates light emitted from the light source, and a projection unit that projects the light emitted from the imager on a projection surface, the projection display apparatus comprising:
a cooling member that cools down an optical unit configured by the light source, the imager, and the projection unit, wherein
the housing member is configured by a first housing member and a second housing member, and
a volume of an airflow passage with respect to the cooling member is changed by changing a positional relationship between the first housing member and the second housing member.

7. The projection display apparatus according to claim 3, wherein
the second housing member includes a power supply unit that supplies the projection display apparatus with power.
